(19) United States
(12) Patent Application Publication
(10) Pub. No.: US 2014/0293465 A1
(43) Pub. Date: Oct. 2, 2014

(54) OPTICAL PRISM AND METHOD FOR BONDING THE SAME

(71) Applicant: CANON KABUSHIKI KAISHA, Tokyo (JP)

(72) Inventors: Minoru Tsuji, Utsunomiya-shi (JP); Toshiki Ishino, Hiratsuka-shi (JP); Takashi Urakawa, Kawasaki-shi (JP)

(73) Assignee: CANON KABUSHIKI KAISHA, Tokyo (JP)

(21) Appl. No.: 14/230,156

(22) Filed: Mar. 31, 2014

(30) Foreign Application Priority Data
Apr. 1, 2013 (JP) 2013-076171

(51) Int. Cl. G02B 5/04; B29C 65/78

(52) U.S. Cl. CPC G02B 5/04; B29C 65/7817
USPC 359/831; 156/64

(57) ABSTRACT

A first optical prism includes a bonding surface for bonding the first optical prism to a second optical prism, a collar element provided on a non-optical effective surface, a first reference portion provided on the collar element to form a reference surface for positioning, and a second reference portion provided at a position different from the first reference portion, in which the second reference portion is provided in an area where the bonding surface is projected in a normal direction of the reference surface.

### BACKGROUND OF THE INVENTION

1. Field of the Invention

The present invention relates to an optical prism and a method for bonding the optical prism.

2. Description of the Related Art

In recent years, a head mounted display (HMD) which a user wears around the head has been developed. The HMD enlarges an image displayed on an image display element such as a liquid crystal display to display the image in front of the user's eye. This enables the user to view a large screen image. The HMD is desired to be downsized to decrease the burden on the user's head. Therefore, an optical system applied to the HMD is also desired to be downsized. As a means of downsizing the optical system, for example, a prism without an optical symmetric axis (hereinafter referred to as a free-curved prism) is used. The free-curved prism can fold an optical path therein and correct a decentration aberration occurring when folding the optical path. For this reason, the free-curved prism is suited for downsizing the optical system.

The free-curved prism used for an image display apparatus such as the HMD is sometimes used with another optical prism bonded thereto to increase the degree of freedom in an optical design.

For example, Japanese Patent Application Laid-Open No. 2005-266588 and Japanese Patent No. 3720464 discuss a technique for bonding a free-curved prism using a positioning portion, which determines a relative position between prisms, formed on the prism. In the configuration discussed in Japanese Patent Application Laid-Open No. 2005-266588, convex pieces protruded from a non-optical surface are formed on two prisms and serve as the positioning portion. In the configuration discussed in Japanese Patent No. 3720464, protrusions are formed on the side faces or the non-optical surfaces of two prisms and serve as the positioning portion.

In order to obtain high optical performance in the free-curved prism used in the optical system of the HMD, an error in attaching the prism to the free-curved prism used in the optical system of the HMD needs to be several tens of micro meters or less. The same holds true for a case where the free-curved prism is bonded to another optical prism and used therewith.

In the configuration discussed in Japanese Patent Application Laid-Open No. 2005-266588, however, if a bonding surface is formed at a position far from the positioning portion, a positional accuracy and an assembly accuracy of the bonding surface are reduced, so that desired optical performance may not be acquired. In the configuration discussed in Japanese Patent No. 3720464, on the other hand, the positioning portion is formed on the bonding surface, so that a positional accuracy of the bonding surface is considered to be high. However, at a site far from the positioning portion on the bonding surface, a positional accuracy and an assembly accuracy are reduced, so that desired optical performance may not be acquired. Further, in a case where the optical prism is bonded by an adhesive, a reaction force of the adhesive may deform the optical prism, so that the optical performance may be reduced.

### SUMMARY OF THE INVENTION

Problems to be solved by the present invention are to prevent or suppress the displacement and deformation of the bonding surface in the optical prism bonded and to prevent or suppress decrease in the optical performance therein.

According to an aspect of the present invention, an optical prism includes a bonding surface for bonding the optical prism to another optical prism, a collar element provided on a non-optical effective surface, a first reference portion provided on the collar element to form a reference surface for positioning, and a second reference portion provided at a position different from the first reference portion, in which the second reference portion is provided in an area where the bonding surface is projected in a normal direction of the reference surface.

According to another aspect of the present invention, in a method for bonding an optical prism to another optical prism, the optical prism includes a bonding surface for bonding the optical prism to another optical prism, a collar element provided on a non-optical effective surface, a first reference portion provided on the collar element to form a reference surface for positioning, and a second reference portion provided at a position different from the first reference portion, the second reference portion being provided in an area where the bonding surface is projected in a normal direction of the reference surface. The method includes correcting a distance between the first and second reference portions with respect to the normal direction of the reference surface, to be a measurement value or a design value of the distance when no deformation occurs and bonding the bonding surface to another optical prism after correcting the distance.

Further features of the present invention will become apparent from the following description of exemplary embodiments with reference to the attached drawings.

### BRIEF DESCRIPTION OF THE DRAWINGS

FIG. 1 is a schematic perspective view of a prism unit to which an optical prism according to a first exemplary embodiment of the present invention is applied.

FIG. 2 is a side view schematically illustrating a state where a first optical prism according to first and second exemplary embodiments of the present invention is subjected to a reaction force of an adhesive bonding structure between first and second optical prisms 100 and 200.

FIG. 3 is a side view schematically illustrating an area where a second reference portion is formed in the first optical prism according to the first exemplary embodiment of the present invention.

FIG. 4 is a side view schematically illustrating a standard distance in the optical prism according to the first exemplary embodiment of the present invention.

FIG. 5 is a side view schematically illustrating the correction of displacement in the second reference portion in the optical prism according to the first and second exemplary embodiments of the present invention.

FIG. 6 is a side view schematically illustrating a method for measuring an amount of displacement of the second reference portion according to the second exemplary embodiment of the present invention.

FIG. 7 is a side view schematically illustrating the measurement of displacement amount of the displaced second reference portion according to the second exemplary embodiment of the present invention.

FIG. 8 is a side view of the prism unit to which an optical prism according to a third exemplary embodiment of the present invention is applied.

FIG. 9 is a side view schematically illustrating a state where a second optical prism is bonded to the deformed first optical prism according to the third exemplary embodiment of the present invention.

### DESCRIPTION OF THE EMBODIMENTS

Various exemplary embodiments, features, and aspects of the invention will be described in detail below with reference to the drawings.

The optical prism according to the present exemplary embodiments of the present invention is a free-curved prism including a free curved surface on an optical effective surface.

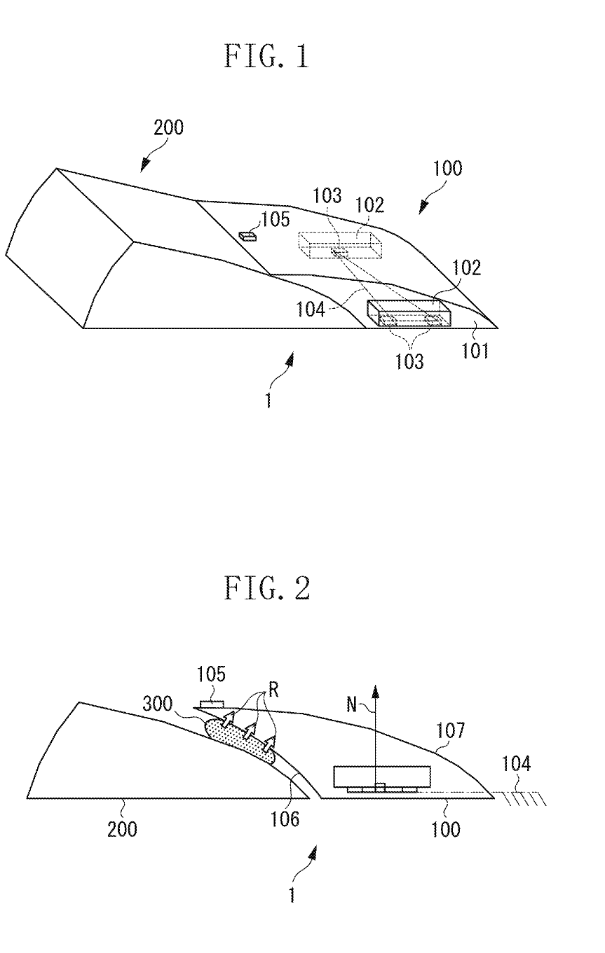

A first exemplary embodiment of the present invention is described below. FIG. 1 is a schematic perspective view illustrating a configuration of a prism unit 1 including an optical prism 100 (hereinafter referred to as a first optical prism 100) and another optical prism 200 (hereinafter referred to as a second optical prism 200) according to the present exemplary embodiment. The first optical prism 100 is bonded to the second optical prism 200 with an adhesive 300.

The first optical prism 100 includes a surface on which an optical effective surface 107 is formed and a surface 101 on which the optical effective surface 107 is not formed. The optical effective surface 107 is formed on a free curved surface or includes the free curved surface. The surface 101 on which the optical effective surface 107 is not formed is defined as a side face 101. Thus, at least one surface of the first optical prism 100 is the optical effective surface 107 including the free curved surface. A collar element 102 is a protrusion formed on the side face 101. A first reference portion 103 is formed on the collar element 102. The first reference portion 103 is a site where a reference surface 104 is formed. The reference surface 104 is used as a reference for positioning the first optical prism 100. For example, as illustrated in FIG. 1, two collar elements 102 are formed on the first optical prism 100. One first reference portion 103 is formed on one collar element 102. Two first reference portions 103 are formed on another collar element 102. The reference surface 104 is a virtual surface passing through the end face (leading edge) of the plurality of the first reference portions 103 (three first reference portions 103 in the example of FIG. 1). In FIG. 1, a shape of the first reference portion 103 is a square boss, however, the shape of the first reference portion 103 is not limited to this shape. The first reference portion 103 may have a shape of a polygonal boss, a cylindrical boss, or a hemispheric boss, for example. The number of the reference portions 103 is not limited to three. In short, the first reference portion 103 may only have the shape and the number which can uniquely define the reference surface 104.

FIG. 2 is a side view schematically illustrating a bonding structure between the first and second optical prisms 100 and 200. As illustrated in FIG. 2, the first optical prism 100 has a bonding surface 106 and is bonded with the second optical prism 200 via the bonding surface 106. It is possible that the first and second optical prisms 100 and 200 are relatively displaced from a design position due to a positioning error when bonded to each other. As illustrated in FIG. 2, in a configuration where the first and second optical prisms are bonded to each other using the adhesive 300, a site near the bonding surface 106 of the first optical prism 100 may be deformed by the reaction force R of an adhesive 300.

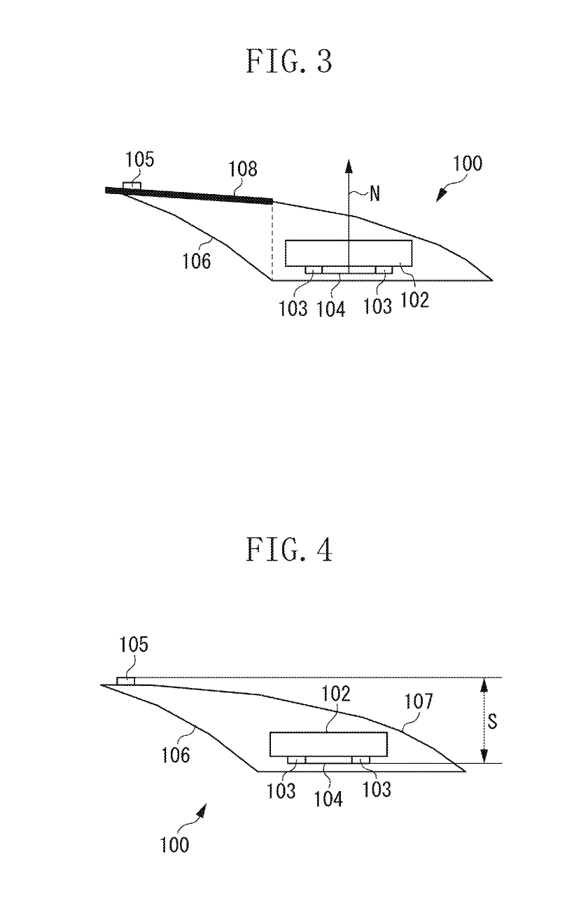

A second reference portion 105 is a site used as a measuring portion for measuring the amount of deformation of the site near the bonding surface 106. Since the site is used for such a purpose, it is desirable to form the second reference portion 105 at a position susceptible to deformation at a site near the bonding surface 106. The second reference portion 105 is provided at a position different from the position where the first reference portion 103 is provided. FIG. 3 is a side view schematically illustrating a position where the second reference portion 105 is provided. In the present exemplary embodiment, as illustrated in FIG. 3, the second reference portion 105 is formed in an area 108 where the bonding surface 106 is projected in a normal direction N of the reference surface 104 (upward in FIG. 3). Furthermore, as illustrated in FIG. 3, a surface substantially parallel to the reference surface 104 is formed on the second reference portion 105. In FIG. 3, the upper surface of the second reference portion 105 is substantially parallel to the reference surface 104. In FIGS. 1 to 3, a shape of the second reference portion 105 is a square boss, however, the shape of the second reference portion 105 is not limited to this shape. In short, the second reference portion 105 may only have a shape that forms a reference for measuring the displacement thereof. Moreover, one second reference portion 105 may be formed in the area 108 where the bonding surface 106 is projected in the normal direction N or the plurality of the second reference portions 105 may be formed in the area 108.

The first reference portion 103 and the second reference portion 105 need to be accurately formed, so that it is preferable to integrally form the first optical prism 100 with resin materials or glass.

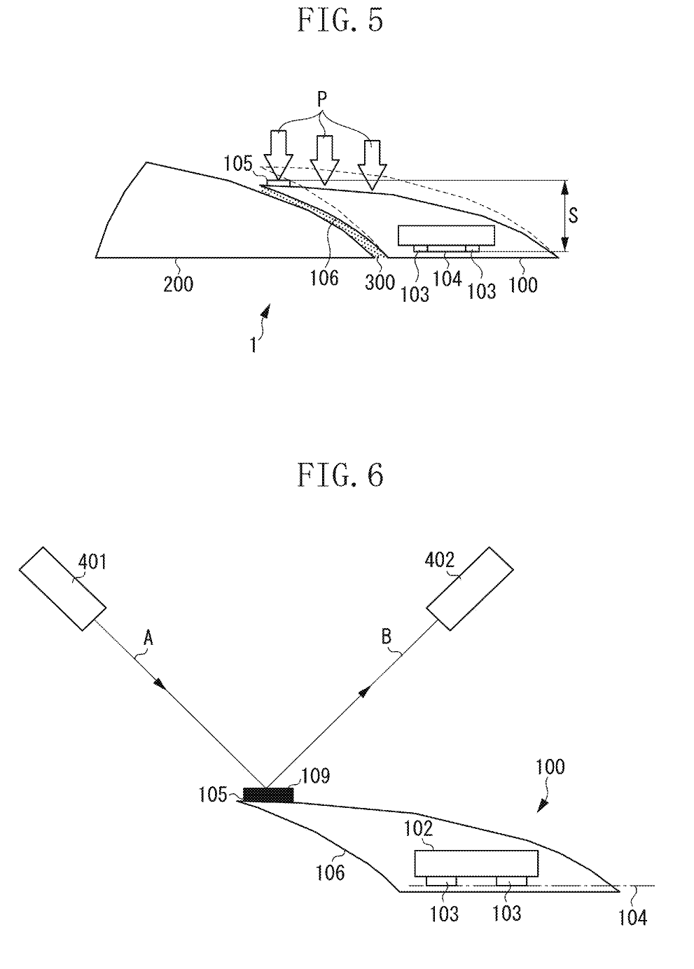

A method for bonding the first optical prism 100 to the second optical prism 200 is described below with reference to FIGS. 4 and 5. FIGS. 4 and 5 are side views schematically illustrating the method for bonding the first optical prism 100 to the second optical prism 200. In the bonding method, a deformation caused by the reaction force R of the adhesive 300 at the site near the bonding surface 106 is corrected using the second reference portion 105.

As illustrated in FIG. 4, a distance S (a distance with respect to the normal direction N) between the reference surface 104 and the second reference portion 105 (the surface substantially parallel to the reference surface 104) is measured prior to bonding. The measured distance S is referred to as standard distance. The standard distance S indicates a distance between the reference surface 104 and the second reference portion 105 with respect to the normal direction N in a state where the first optical prism 100 is not deformed. The standard distance S is referenced when correcting a deformation occurring on the second reference portion 105 in the bonding process. As described above, the surface substantially parallel to the reference surface 104 is formed on the second reference portion 105. Such a configuration can eliminate the influence of an angle error in measuring the standard distance S. Therefore, the standard distance S can be accurately measured.

As illustrated in FIG. 5, the position of the second optical prism 200 which is coated with the adhesive 300 is fixed and the first optical prism 100 is positioned at the design position. The first optical prism 100 may be deformed by the reaction force R of the adhesive 300 (refer to FIG. 2). At this point, the position of the second reference portion 105 is measured to obtain an amount of displacement from the standard distance S. The amount of displacement from the standard distance S is measured by a measuring instrument with a measurement accuracy of a micrometer, such as a lever-actuated dial gauge, for example, to satisfy the accuracy required for bonding a prism having a free curved surface.

As illustrated in FIG. 5, an external force P is applied to the second reference portion 105 or the surface on which the second reference portion 105 is formed to perform a correction such that a distance between the reference surface 104 and the second reference portion 105 with respect to the normal direction N becomes the standard distance S. Finally, the adhesive 300 is hardened with the external force P acting on the adhesive 300. The distance between the reference surface 104 and the second reference portion 105 may be made equal to the standard distance S not at the time of the correction but after the adhesive 300 is hardened, in consideration of shrinkage of the adhesive 300 when hardened.

According to the present exemplary embodiment, the second reference portion 105 is formed in the area 108 where the bonding surface 106 is projected in the normal direction N of the reference surface 104 to accurately measure the amount of deformation at the site near the bonding surface 106. Deformation at the site near the bonding surface 106 is corrected based on the measured value at the time of positioning to prevent or suppress decrease in optical performances due to bonding.

In particular, if the first optical prism 100 includes at least one free curved surface, the sensitivity of the free curved surface may be high from the design point of view. This causes displacement on the bonding surface 106 and if a relative position between the bonding surface 106 and the free curved surface is changed, the optical performances may be significantly decreased. In such a case, the bonding method according to the present exemplary embodiment is used to prevent and suppress decrease in the optical performance. In particular, the second reference portion 105 is formed in the area 108 where the bonding surface 106 is projected in the normal direction N of the reference surface 104 to effectively prevent and suppress decrease in a positioning accuracy at the site near the bonding surface 106.

A second exemplary embodiment of the present invention is described below. The components and sites common to those of the first exemplary embodiment are given the same reference numerals, so that the description thereof is omitted. In the second exemplary embodiment, the displacement of the second reference portion 105 is measured in a non-contact manner. At least one surface of the first optical prism 100 according to the second exemplary embodiment is an optical effective surface including a free curved surface.

FIG. 6 is a schematic diagram illustrating a method for measuring an amount of displacement of the second reference portion 105. As illustrated in FIG. 6, a mirror surface portion 109 directly reflecting light is formed on the second reference portion 105 of the first optical prism 100. The method for forming the mirror surface portion 109 includes evaporating metal such as aluminum or silver on the second reference portion 105 or mirror-polishing the second reference portion 105.

As illustrated in FIG. 6, in the second exemplary embodiment, a light source 401 and a light intensity measuring device 402 are used for measuring an amount of displacement of the second reference portion 105.

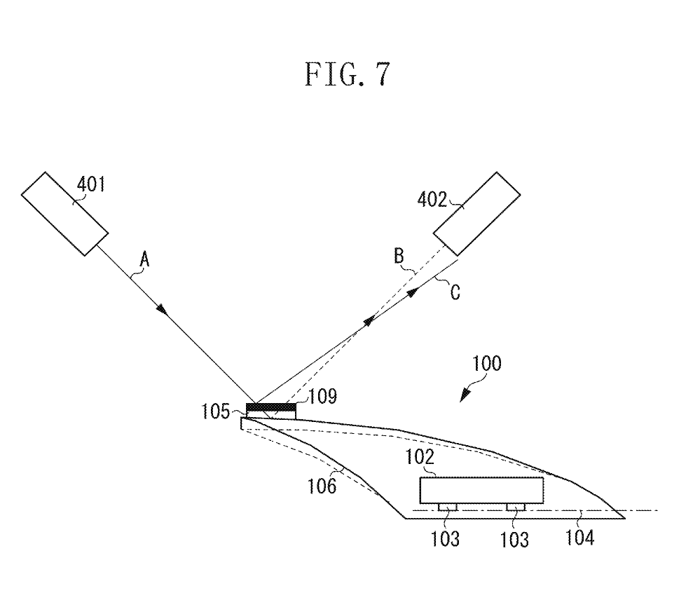

The light source 401 irradiates the mirror surface portion 109 of the second reference portion 105 with light. An arrow A in FIG. 6 indicates an optical path of the light with which the mirror surface portion 109 is irradiated. Light reflected by the mirror surface portion 109 is incident on the light intensity measuring device 402. An arrow B in FIG. 6 indicates an optical path of the reflected light. The light intensity measuring device 402 is capable of measuring the intensity of the reflected light incident thereon. The light intensity measuring device 402 is set to have such a posture that the measurement value of the reflected light is maximized in a state where the first optical prism 100 is not deformed. FIG. 7 is a schematic diagram illustrating change in the optical path of the reflected light. A broken line in FIG. 7 indicates a state where the first optical prism 100 is not deformed. A solid line in FIG. 7 indicates a state where the first optical prism 100 is deformed. An arrow C indicates an example of the optical path of the reflected light in a case where the first optical prism 100 is deformed. As illustrated in FIG. 7, if the first optical prism 100 is deformed and the second reference portion 105 is displaced, the direction in which the mirror surface portion 109 reflects the irradiation light is changed, and the optical path of the reflected light is changed from the optical path B to the optical path C. This decreases the reflected light incident on the light intensity measuring device 402 and the measurement value of amount of the reflected light. Then, a position displacement appearing on the second reference portion 105 is detected by a measurement value of the light intensity measuring device 402. The position of the second reference portion 105 is corrected to increase the measurement value of amount of the reflected light. This enables preventing and suppressing decrease in the optical performances.

The present exemplary embodiment can exhibit an effect similar to that of the first exemplary embodiment. According to the present exemplary embodiment, a position displacement appearing on the second reference portion 105 is measured in a non-contact manner. Unlike a contact measurement, such a configuration eliminates the need for bringing a probe into contact, so that the second reference portion 105 is not displaced by an external force applied by the contact of the probe. This can prevent the position displacement from occurring at the time of measurement. The above configuration is more effective in preventing and suppressing decrease in the optical performances than the configuration in which an amount of displacement is measured in a contact manner.

A third exemplary embodiment of the present invention is described below.

A first optical prism 500 and a second optical prism 600 bonded to the first optical prism 500 according to the third exemplary embodiment are different in shape from the first and second optical prisms according to the first exemplary embodiment.

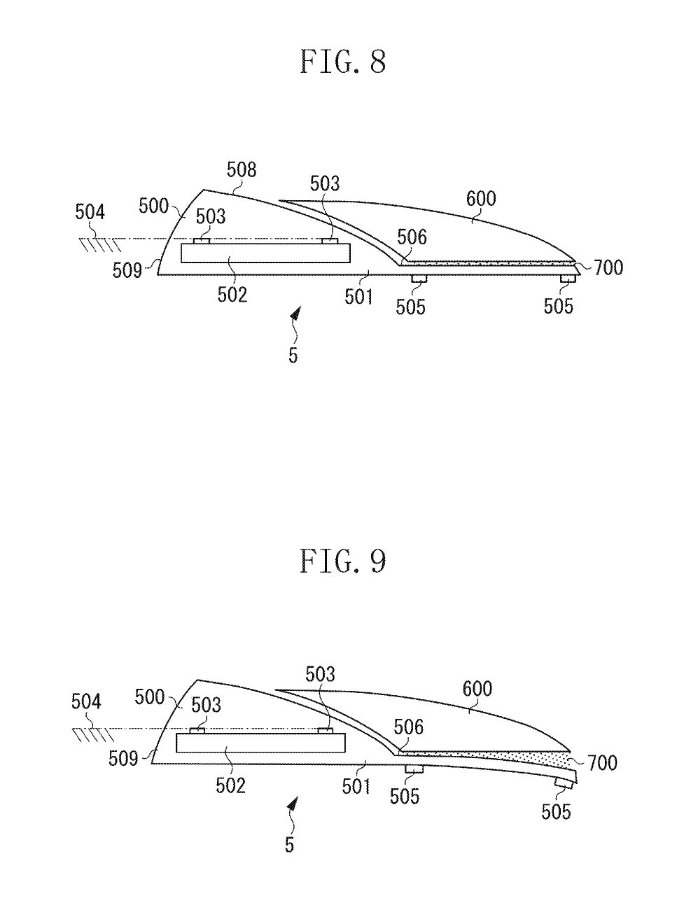

FIG. 8 is a side view schematically illustrating a configuration of a prism unit 5. The prism unit 5 illustrated in FIG. 8 is formed such that the first optical prism 500 and the second optical prism 600 according to the present exemplary embodiment are bonded to each other with an adhesive 700. As illustrated in FIG. 8, there are formed optical effective surfaces 508 and 509, a side face 501 which is not the optical effective surfaces 508 and 509, a collar element 502, a plurality of first reference portions 503 and second reference portions 505, and a bonding surface 506 on the first optical prism 500. The optical effective surfaces 508 and 509 are formed on the free curved surface or include the free curved surface. At least one surface of the first optical prism 500 is the optical effective surface including the free curved surface. The reference surface 504 is defined by the plurality of first reference portions 503. As illustrated in FIG. 9, the first optical prism 500 includes an extending thin lingual portion and the second reference portion 505 is formed on the thin lingual portion. The optical effective surfaces 508 and 509, the first reference portion 503, the second reference portion 505, and the bonding surface 506 have functions common with those of the optical effective surface 107, the first reference portion 103, the second reference portion 105, and the bonding surface 106 according to the first exemplary embodiment, respectively. The collar element 502 and the first reference portion 503 are common in configuration with those of the first exemplary embodiment.

A method for bonding the first optical prism 500 to the second optical prism 600 is described below.

As illustrated in FIG. 9, if the bonding surface 506 of the first optical prism 500 is formed on the thin lingual portion, it is not easy to maintain the accuracy of a positional relationship between the first and second reference portions 503 and 505 because the thin lingual portion is liable to deform. For this reason, as is the case with the first exemplary embodiment, if the measurement value of a distance between the reference surface 504 and the second reference portion 505 in the normal direction N is taken as the standard distance S after the molding is performed, decrease in the accuracy of bonding cannot be prevented or suppressed.

Therefore, in the present exemplary embodiment, a design value of a distance between the reference surface 504 and the second reference portion 505 is taken as the standard distance S. If the design value of a distance between the reference surface 504 and the second reference portion 505 is the standard distance S, decrease in optical performances can be prevented or suppressed by correcting deformation so that the measurement value becomes close to the design value.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-076171 filed Apr. 1, 2013, which is hereby incorporated by reference herein in its entirety.

What is claimed is:

1. An optical prism comprising:
a bonding surface for bonding the optical prism to another optical prism;
a collar element provided on a non-optical effective surface;
a first reference portion provided on the collar element to form a reference surface for positioning; and
a second reference portion provided at a position different from the first reference portion;
wherein the second reference portion is provided in an area where the bonding surface is projected in a normal direction of the reference surface.

2. The optical prism according to claim 1, wherein the second reference portion includes a surface substantially parallel to the reference surface.

3. The optical prism according to claim 2, wherein the surface substantially parallel to the reference surface includes a mirror surface portion.

4. The optical prism according to claim 1, further comprising at least one free curved surface.

5. A method for bonding an optical prism to another optical prism, the optical prism including a bonding surface for bonding the optical prism to another optical prism, a collar element provided on a non-optical effective surface, a first reference portion provided on the collar element to form a reference surface for positioning, and a second reference portion provided at a position different from the first reference portion, the second reference portion being provided in an area where the bonding surface is projected in a normal direction of the reference surface, the method comprising:
correcting a distance between the first and second reference portions in the normal direction of the reference surface, to be a measurement value or a design value of the distance when no deformation occurs; and
bonding the bonding surface to another optical prism after correcting the distance.
